(19) United States
(12) Patent Application Publication
(10) Pub. No.: US 2026/0318195 A1
(43) Pub. Date: Oct. 15, 2026

(54) METHOD FOR EVALUATING PRESSURE-BEARING PLUGGING PERFORMANCE OF TEMPERATURE-RESPONSIVE ADHESIVE LOST CIRCULATION MATERIAL FOR DEEP FRACTURED FORMATIONS

(71) Applicant: Southwest Petroleum University, Chengdu (CN)

(72) Inventors: Chengyuan Xu, Chengdu (CN); Jiangcheng Zhong, Chengdu (CN); Lei Liu, Chengdu (CN); Yingrui Bai, Chengdu (CN); Senwen Luo, Chengdu (CN); Fan Liu, Chengdu (CN); Long Li, Chengdu (CN); Mingming Zhu, Chengdu (CN); Kun Guo, Chengdu (CN); Ling Lin, Chengdu (CN)

(21) Appl. No.: 19/462,798

(22) Filed: Jan. 28, 2026

(30) Foreign Application Priority Data
Mar. 18, 2025 (CN) 202510315867.4

(51) Int. Cl. E21B 49/00; G01N 3/08

(52) U.S. Cl. CPC E21B 49/00; G01N 3/08; G01N 2203/0019; G01N 2203/0266

(57) ABSTRACT

The present application discloses a method for evaluating pressure-bearing plugging performance of a temperature-responsive adhesive lost circulation material for deep fractured formations, and belongs to the technical field of lost circulation control. The method includes: fabricating a cylindrical specimen by using a temperature-responsive adhesive lost circulation material according to a preset dimension, where the preset dimension includes a diameter and a length of the specimen; measuring a uniaxial compressive strength of the specimen and a strain corresponding to the uniaxial compressive strength; and evaluating pressure-bearing plugging performance of the temperature-responsive adhesive lost circulation material according to the uniaxial compressive strength of the specimen and the strain corresponding to the uniaxial compressive strength, where the larger a ratio of the uniaxial compressive strength to the strain corresponding to the uniaxial compressive strength, the better the pressure-bearing performance of the plugging layer.

### CROSS-REFERENCE TO RELATED APPLICATIONS

This application claims priority to Chinese Patent Application No. 202510315867.4, filed on Mar. 18, 2025, which is hereby incorporated by reference in its entirety.

### TECHNICAL FIELD

The present application belongs to the technical field of lost circulation control, also relates to new material detection and functional testing, and particularly relates to a method for evaluating pressure-bearing plugging performance of a temperature-responsive adhesive lost circulation material for deep fractured formations.

### BACKGROUND

A temperature-responsive adhesive lost circulation material does not undergo solidification under room temperature, but crosslinks with an amine crosslinking agent upon reaching a certain temperature to form a bulk solidified body, which is beneficial for solidification into a plug under bottomhole temperature conditions to block a lost circulation channel and enhance retention capability of the temperature-responsive adhesive lost circulation material in the lost circulation channel. Therefore, the temperature-responsive adhesive lost circulation material is particularly suitable for a high-temperature and high-pressure environment of a deep fractured formation. There are various temperature-responsive adhesive lost circulation materials, for example, a temperature-responsive material disclosed by Wang Weiji et al. (Preparation and properties of thermosensitive poly(NIPAm-co-AA)/nano-SiO2 composite blocking agent for shale gas reservoir [J]. Acta Petrolei Sinica, 2015, 36(3): 378-384).

The temperature-responsive adhesive lost circulation material enhances pressure-bearing performance of a plugging layer by improving adhesive force between particles and particles and adhesive force between particles and fracture surfaces. Currently, the temperature-responsive adhesive lost circulation material is generally screened by a pressure-bearing lost circulation experiment; however, the pressure-bearing lost circulation experiment requires preparation of drilling fluid and a fracture model, also requires related grading of a lost circulation material, involves complicated operations, consumes a long time, and causes large experimental errors. Therefore, a rapid and effective manner for evaluating performance of a temperature-responsive adhesive lost circulation material is urgently needed.

### SUMMARY

To solve the above problem, the present application provides a method for evaluating pressure-bearing plugging performance of a temperature-responsive adhesive lost circulation material for deep fractured formations, where the pressure-bearing performance of a plugging layer is evaluated by a uniaxial compressive strength of the plugging layer and a strain corresponding to the uniaxial compressive strength, and the evaluation accuracy is significantly improved.

To achieve the above objective, the present application provides the following solution:

A method for evaluating pressure-bearing plugging performance of a temperature-responsive adhesive lost circulation material for deep fractured formations includes the following steps:
S1. fabricating a cylindrical specimen by using a temperature-responsive adhesive lost circulation material according to a preset dimension, where the preset dimension includes a diameter and a length of the specimen;
S2. measuring a uniaxial compressive strength of the specimen and a strain corresponding to the uniaxial compressive strength; and
S3. evaluating pressure-bearing plugging performance of the temperature-responsive adhesive lost circulation material according to the uniaxial compressive strength of the specimen and the strain corresponding to the uniaxial compressive strength, where the larger a ratio of the uniaxial compressive strength to the strain corresponding to the uniaxial compressive strength, the better the pressure-bearing performance of the plugging layer.

In the present application, the uniaxial compressive strength of the specimen is related to the specimen dimension, where the uniaxial compressive strength of the specimen is very high when a length-to-diameter ratio is very small, and the specimen is prone to damage due to elastic instability and uneven stress distribution when the length-to-diameter ratio is very large, which reduces the uniaxial compressive strength of the specimen. In a specific embodiment of the present application, the length-to-diameter ratio of the specimen is 2 to 3.

In the present application, the measurement of the uniaxial compressive strength can be performed by using a measuring device in the prior art, and then a stress-strain curve is plotted, where a peak strength of the curve represents the uniaxial compressive strength of the specimen.

In a specific embodiment of the present application, in the step S1, the preset dimension includes a diameter of 50 mm and a length-to-diameter ratio of 2; in the step S3, the pressure-bearing plugging performance of the temperature-responsive adhesive lost circulation material is evaluated by a bonding performance evaluation index, where a calculation formula of the bonding performance evaluation index is as follows:

$$B = \frac{2}{1 + {e}^{- \frac{{σ}_{max}}{1 + ε}}} - 1$$

where B represents the bonding performance evaluation index in a range of 0 to 1, and a larger value indicates better performance; [symbol] max represents the uniaxial compressive strength, that is, a peak strength, in MPa; ε represents strain, that is, the strain corresponding to the peak strength.

Further, the step S3 further includes determining a pressure-bearing performance grade of the temperature-responsive adhesive lost circulation material according to the bonding performance evaluation index and evaluation criteria, where the evaluation criteria include: 0≤B≤0.2, weak pressure-bearing performance; 0.2<B≤0.4, relatively weak pressure-bearing performance; 0.4<B≤0.6, medium pressure-bearing performance; 0.6<B≤0.8, medium-to-strong pressure-bearing performance; and 0.8<B≤1, strong pressure-bearing performance.

Compared with the prior art, the present application has the following beneficial effects:

The present application provides a method for scientifically evaluating pressure-bearing plugging performance of a temperature-responsive adhesive lost circulation material, where mechanical performance and sealing performance of the material are systematically quantified by combining stress and strain, which can accurately reflect pressure-bearing plugging performance of the material under actual working conditions, and evaluation results have high accuracy. The evaluation parameters are mainly based on results of compressive experiments, and operation is simple.

### BRIEF DESCRIPTION OF THE DRAWINGS

FIG. 1 is a stress-strain curve of a temperature-responsive adhesive lost circulation material with LCC200 as a core;

FIG. 2 is a stress-strain curve of a temperature-responsive adhesive lost circulation material with walnut shell as a core; and

FIG. 3 is a stress-strain curve of a temperature-responsive adhesive lost circulation material with porous basalt as a core.

### DESCRIPTION OF EMBODIMENTS

The present application is further described in detail below in combination with embodiments and the accompanying figures; however, the embodiments of the present application are not limited thereto.

In this embodiment, specimens are pressed by using a hot-press plug module press, and stress-strain data of the specimens are measured by using a microcomputer-controlled electronic universal testing machine in the model of ETM305D. Those skilled in the art should understand that instruments capable of implementing the present application are not limited to the foregoing instruments. Meanwhile, in this embodiment, the “cross-sectional area” represents a maximum cross-sectional area of a cylinder formed by using the module press.

In the following embodiments, LCC200 particles are from Chengdu Dedao Industrial Co., Ltd., where LCC200 is a high-strength inert particle material, does not react with acid solution, and has a mass crushing ratio of 4.1% under 30.0 MPa pressure; E-12 and E-20 are thermosetting epoxy resins, where E-12 is from Chuzhou Hui-Sheng Electronic Materials Co., Ltd., and E-20 is from Sinopec Baling Petrochemical Co., Ltd.; and GZD is from Sichuan Southwest Petroleum University Jinniu Petroleum Technology Co., Ltd., where GZD is an acid-soluble removable filler material with a mesh size of 18-24.

### Embodiment 1

S1. A cylindrical specimen was fabricated by using a temperature-responsive adhesive lost circulation material, including the following steps S11 to S13.
S11. The temperature-responsive adhesive lost circulation material was prepared as follows: LCC200 particles (6-10 mesh) were used as a core material, and thermosetting resin was epoxy resin E-12. The core material was cleaned and dried, and a total mass of the core material was weighed. Based on the dry mass of the core material, 10 wt % of epoxy resin, 0.1 wt % of dicyandiamide (curing agent), 0.1 wt % of silane coupling agent (interface modifier), and 0.2 wt % of 2-methylimidazole (catalyst) were weighed for later use. The epoxy resin was mixed with dichloromethane at a mass ratio of 1:3 and stirred until completely dissolved. Dicyandiamide was then added with continuous stirring to form a homogeneous solution, which was referred to as the epoxy resin solution. 2-Methylimidazole was dissolved in anhydrous ethanol to prepare a catalytic system. The silane coupling agent (γ-aminopropyltriethoxysilane) and the epoxy resin solution were subsequently added, and the mixture was stirred for 5 min to form a mixed solution. The mixed solution was transferred together with the core material particles into a coating machine feed tank, and additional dichloromethane was added until the particle layer was completely immersed. The coating machine preheated to 50° C. was started and rotated at a uniform speed, and a hot air circulation system was used to accelerate solvent evaporation. After a uniform coating layer was formed, the machine was stopped, and the coated particles were transferred to a cooling tray to naturally cool to room temperature. Finally, the agglomerated particles were gently separated to obtain a temperature-responsive adhesive lost circulation material with uniform particle size.
S12. A lost circulation slurry was prepared as follows: based on the total mass of water, 0.1 wt % of sodium hydroxide, 0.2 wt % of sodium carbonate, 6 wt % of bentonite, 0.4 wt % of carboxymethyl cellulose sodium (CMC), and 0.4 wt % of xanthan gum were weighed for later use. Sodium hydroxide and sodium carbonate were dissolved in water and stirred until uniform, CMC and xanthan gum were then slowly added, followed by addition of bentonite to the solution. The mixture was thoroughly mixed until uniform and viscous, and allowed to stand for 10 min before use.
S13. The temperature-responsive adhesive lost circulation material prepared in the step S11 was mixed with the lost circulation slurry prepared in the step S12 at a mass ratio of 1:4 and injected into a hot-press plug module press. The mixture was cured at a temperature of 90° C. and a pressure of 1 MPa for 6 h to obtain a specimen.

The specimen was removed from the instrument and cooled to room temperature, and the dimensions of the specimen were measured, where specific dimensions are shown in Table 1.
S2. The uniaxial compressive strength of the specimen and strain corresponding to the uniaxial compressive strength were measured. In this step, uniaxial mechanical property testing was performed on a cured sample by using an electronic universal testing machine. The specific steps were as follows:
S21. The sample was placed in a fixture of the testing machine, and a loading direction of the sample was aligned with a pressure axis of the testing machine.
S22. An external pressure was gradually applied by using a uniformly accelerated loading mode at a loading rate of 0.5 mm/min until fracture of the sample occurred, the loading was stopped, the deformation data and stress data of the cylindrical body were recorded, and a stress-strain curve was plotted according to testing data, as shown in FIG. 1.
S23. The uniaxial compressive strength of the sample and strain corresponding to the uniaxial compressive strength were obtained according to the stress-strain curve, as shown in Table 1.
S3. A bonding performance evaluation index of a plugging layer was evaluated according to the uniaxial compressive strength of the specimen and the strain corresponding to the uniaxial compressive strength.

$$B = \frac{2}{1 + {e}^{- \frac{{σ}_{max}}{1 + ε} - 1}} - 1 = \frac{2}{1 + e {\vert}^{- \frac{3.723}{1 + 0.109}}} - 1 = 0.933 .$$

### Embodiment 2

The steps in this embodiment were the same as those of Embodiment 1, except that specimens were different. In this embodiment, walnut shell particles (6-8 mesh) were used as a core material, and the specimen was prepared according to steps of Embodiment 1.

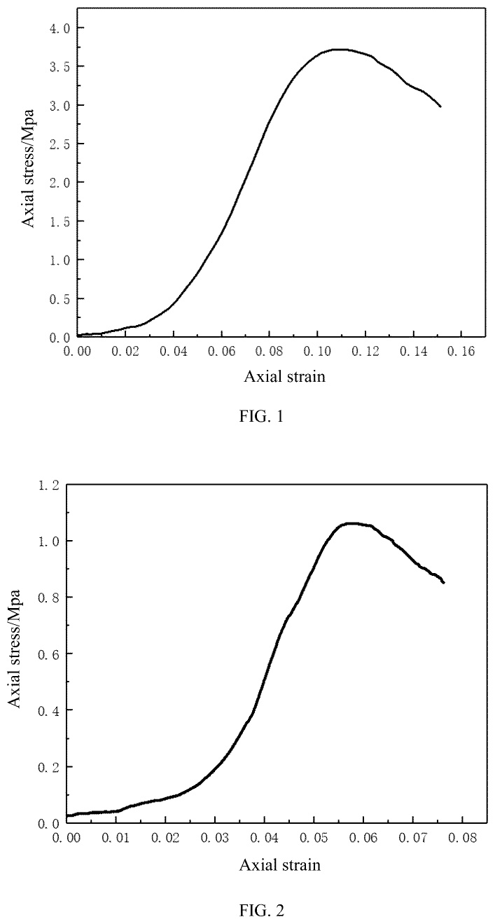

The dimensions of the specimen in this embodiment are shown in Table 1, a stress-strain curve of the specimen is shown in FIG. 2, and the uniaxial compressive strength, the strain, and the bonding performance evaluation index are shown in Table 2.

### Embodiment 3

The steps in this embodiment were the same as those of Embodiment 1, except that specimens were different. In this embodiment, porous basalt particles (6-10 mesh) were used as a core material, thermosetting resin was epoxy resin E-20, and the specimen was prepared according to steps of Embodiment 1.

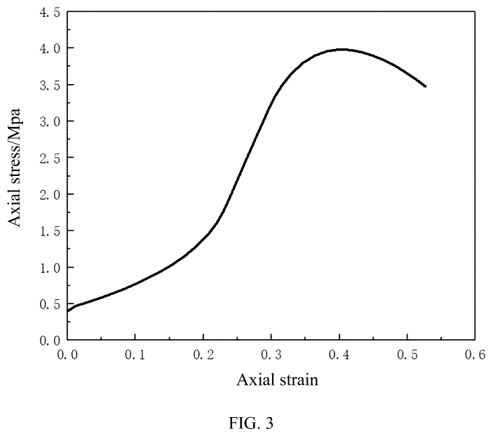

The dimensions of the specimen in this embodiment are shown in Table 1, a stress-strain curve of the specimen is shown in FIG. 3, and the uniaxial compressive strength, the strain, and the bonding performance evaluation index are shown in Table 2.

TABLE 1
Dimensions of specimens.

| No. | Core material | Cross-sectional area S (cm²) | Length (cm) |
|---|---|---|---|
| Embodiment 1 | Lcc200 | 19.635 | 10.2 |
| Embodiment 2 | Walnut shell | 19.855 | 10.5 |
| Embodiment 3 | Porous basalt | 19.725 | 10.3 |

TABLE 2
Uniaxial test results and bonding performance evaluation index of
specimens

| | | Maximum | | | Bonding |
|---|---|---|---|---|---|
| | | loading | Compressive | | performance |
| | Core | force | strength | | evaluation |
| No. | material | (kN) | (MPa) | Strain | index |
| Embodiment | Lcc200 | 7.309 | 3.722 | 0.109 | 0.933 |
| 1 | | | | | |
| Embodiment | Walnut | 2.087 | 1.051 | 0.056 | 0.460 |
| 2 | shell | | | | |
| Embodiment | Porous | 7.819 | 3.964 | 0.399 | 0.889 |
| 3 | basalt | | | | |

As a result, the bonding performance evaluation index of Embodiment 1 was 0.933, and the pressure-bearing performance was strong; the bonding performance evaluation index of Embodiment 2 was 0.460, and the pressure-bearing performance was moderate; the bonding performance evaluation index of Embodiment 3 was 0.889, and the pressure-bearing performance was strong. Based on decreasing pressure-bearing performance, the embodiments were ranked in the following order: Embodiment 1, Embodiment 3, and Embodiment 2.

### Test Example 1

To verify the accuracy of evaluating the pressure-bearing performance using the bonding performance evaluation index, a lost circulation material was prepared by using the temperature-responsive adhesive lost circulation material obtained in the foregoing embodiments, and the pressure-bearing lost circulation plugging experiment was performed to determine the actual pressure-bearing performance of the material. The specific steps were as follows:
(1) The temperature-responsive adhesive lost circulation materials prepared in Embodiments 1-3 were respectively used as bridging materials, and GZD was used as a filling material, to formulate lost circulation formulations. The dosage of each substance in the lost circulation formulations was calculated based on the mass of water in the base lost circulation slurry. The specific formulations are shown in Table 3.

The base lost circulation slurry formulation was as follows: water+4 wt % bentonite+0.2 wt % sodium carbonate+0.1 wt % sodium hydroxide+0.3 wt % sodium carboxymethyl cellulose+0.4 wt % xanthan gum, where all dosages were calculated based on the mass of water.

TABLE 3
Composition of each lost circulation formulation

| | Type and dosage of | Total |
|---|---|---|
| Formulation | lost circulation materials | dosage |
| Formulation | 7 wt % temperature-responsive | 10 |
| 1 | adhesive lost circulation | wt % |
| | material of Embodiment 1 + 3 wt % | |
| | GZD (18-24 mesh) | |
| Formulation | 7 wt % temperature-responsive | 10 |
| 2 | adhesive lost circulation | wt % |
| | material of Embodiment 2 + 3 wt % | |
| | GZD (18-24 mesh) | |
| Formulation | 7 wt % temperature-responsive | 10 |
| 3 | adhesive lost circulation | wt % |
| | material of Embodiment 3 + 3 wt % | |
| | GZD (18-24 mesh) | |

(2) The forward pressure-bearing capability of a fracture plugging layer was tested, including the following steps: a variable-aperture fractured rock sample with an initial fracture width of 5.0-3.0 mm (fracture inlet width 5.0 mm, fracture outlet width 3.0 mm) was placed into a core holder equipped with a heater. A confining pressure of 25 MPa was applied, and a downstream valve of the core holder was closed. The prepared lost circulation slurry was poured into an upstream vessel of the core holder, and an electric agitator in the vessel was started at a rotation speed of 150 r/min. A pump connected to the vessel was started to displace fluid at a rate of 1 mL/min, thereby increasing the pressure in the vessel to 1.0 MPa. After stabilizing for 5 min, the heater was activated and set to 90° C. When the set temperature was reached, heating continued for 30 min. Subsequently, the downstream valve of the core holder was opened, and the initial fluid loss was recorded. The fluid displacement continued at 1 mL/min, and the vessel pressure was further increased. When the vessel pressure suddenly dropped and did not recover, the fracture plugging layer was considered to have failed, the experiment was stopped, and the peak pressure was recorded as the pressure-bearing capability of the fracture plugging layer. The final fluid loss at the peak pressure was recorded as the cumulative fluid loss. The results of the forward pressure-bearing test of fracture plugging layers for the lost circulation formulations are shown in Table 4.

TABLE 4
Forward pressure-bearing test results of fracture plugging
layers for lost circulation plugging formulations

| | | Pressure- | Initial | |
|---|---|---|---|---|
| | Fracture | bearing | fluid | Cumulative |
| | width/ | capability/ | loss/ | fluid |
| Formulation | mm | MPa | mL | loss/mL |
| Formulation 1 | 5-3 | 14.72 | 4.3 | 8.9 |
| Formulation 2 | (Inlet 5, | 10.86 | 6.2 | 17.3 |
| Formulation 3 | Outlet 3) | 12.97 | 4.9 | 11.7 |

As shown in Table 4, the pressure-bearing plugging performance of Formulation 1 (in which the temperature-responsive adhesive lost circulation material of Embodiment 1 was used) was superior to that of Formulation 3 (in which the temperature-responsive adhesive lost circulation material of Embodiment 3 was used), and the pressure-bearing plugging performance of Formulation 3 was superior to that of Formulation 2 (in which the temperature-responsive adhesive lost circulation material of Embodiment 2 was used). The evaluation results were consistent with those obtained directly using the bonding performance evaluation index, the relative magnitude of the bonding performance evaluation index could be used to determine the relative pressure-bearing plugging performance of each formulation, thereby allowing uniaxial compressive performance testing to replace the pressure-bearing plugging testing.

The above descriptions are merely preferred specific embodiments of the present application, however, the protection scope of the present application is not limited thereto, and any modifications and substitutions that can be easily conceived by those skilled in the art within the technical scope disclosed by examples of the present application shall fall within the protection scope of the present application.

What is claimed is:

1. A method for evaluating pressure-bearing plugging performance of a temperature-responsive adhesive lost circulation material for deep fractured formations, comprising:
S1. fabricating a cylindrical specimen by using a temperature-responsive adhesive lost circulation material according to a preset dimension, wherein the preset dimension is a diameter of 50 mm and a length-to-diameter ratio of 2;
S2. measuring a uniaxial compressive strength of the specimen and a strain corresponding to the uniaxial compressive strength;
S3. evaluating the pressure-bearing plugging performance of the temperature-responsive adhesive lost circulation material by using a bonding performance evaluation index, wherein the larger the bonding performance evaluation index, the better the pressure-bearing performance of a plugging layer;
the bonding performance evaluation index is calculated by the following formula:
$$B = \frac{2}{1 + {e}^{- \frac{{σ}_{max}}{1 + ε}}} - 1$$
wherein B represents the bonding performance evaluation index; [symbol] max represents the uniaxial compressive strength; and ε represents the strain.

2. The method for evaluating the pressure-bearing plugging performance of the temperature-responsive adhesive lost circulation material for deep fractured formations according to claim 1, wherein the step S3 further comprises determining a pressure-bearing performance grade of the temperature-responsive adhesive lost circulation material according to the bonding performance evaluation index and evaluation criteria, wherein the evaluation criteria comprise: 0≤B≤0.2, weak pressure-bearing performance; 0.2<B≤0.4, relatively weak pressure-bearing performance; 0.4<B≤0.6, medium pressure-bearing performance; 0.6<B≤0.8, medium-to-strong pressure-bearing performance; and 0.8<B≤1, strong pressure-bearing performance.
